(19) United States
(12) Patent Application Publication
(10) Pub. No.: US 2020/0082322 A1
(43) Pub. Date: Mar. 12, 2020

(54) COMPUTER NETWORKED CALENDAR

(71) Applicant: AGENDRIX, Sherbrooke (CA)

(72) Inventor: Andre GAUTHIER, Sherbrooke (CA)

(21) Appl. No.: 16/448,475

(22) Filed: Jun. 21, 2019

Related U.S. Application Data
(63) Continuation of application No. 15/937,135, filed on Mar. 27, 2018.
Application No. 15/937,135 is a continuation of application No. 14/808,680, filed on Jul. 24, 2015, now abandoned.
Application No. 14/808,680 is a continuation-in-part of application No. PCT/CA2013/050731, filed on Sep. 25, 2013.
(60) Provisional application No. 61/880,905, filed on Sep. 21, 2013.

(51) Int. Cl. G06Q 10/06; G06Q 10/10

(52) U.S. Cl. CPC G06Q 10/063118; G06Q 10/1093; G06Q 10/1095

(57) ABSTRACT

A calendar system is disclosed that allows a user to create his or her own account, to join or be joined to an organization for staffing and/or scheduling purposes, to use the account for calendar or scheduling outside of the organization, and to retain at least a portion of the calendar database after severing membership with the organization. Embodiments of the present invention allow a user to indicate said user's availability for work or participation differently for the various organizations to which the user belongs.

### CROSS-REFERENCE TO RELATED APPLICATIONS

The present application is a continuation of U.S. application Ser. No. 15/937,135 filed on 27 Mar. 2018, which is a continuation of U.S. application Ser. No. 14/808,680 filed on 24 Jul. 2015, which is a continuation-in-part of international PCT application serial number PCT/CA2013/050731 filed on 25 Sep. 2013 and designating the United States, and claims priority to U.S. provisional patent application No. 61/880,905 filed on 21 Sep. 2013, the entireties of which are incorporated herein by reference.

### TECHNICAL FIELD

The present invention relates to networked scheduling or calendar systems.

### BACKGROUND

Computer-based calendaring systems are in widespread use. The most popular solutions available to mass consumers like Google Calendar or Yahoo! Mail Calendar allow users to create an account and schedule their own activities together. Some of these solutions allow for some integration with other users/individuals, such as inviting others to a scheduled appointment time and keeping track of who is able to participate. Many systems allow others to see availabilities. However, such systems assume that time is either appointment time (booked) or free time (i.e. available to everybody).

Calendar systems specializing in managing the availability of resources as a function of time typically operate within a closed database. Employee files or records are opened on such systems, typically by the administrator of the system, and employees are then asked to use the functionality of the system, usually through a login code or password. Once an employee leaves the organization, he loses access to his account and leaves with no personal time or scheduling information, or information on his work history, as the information and history remain captive within the closed database.

Systems that are adapted for scheduling staff within an organization are also known in the art. For example, see http://en.wikipedia.org/wiki/Employee_scheduling_software.

Most part-time workers maintain lives with multiple commitments, such as education/training programs, personal/family obligations and other part-time jobs. In many workplaces, it is rare for a part-time employee to keep a fixed work schedule. Scheduling workers is a challenge for both employers and employees. Missing a shift due to a scheduling conflict is a loss of revenue for the employee, while being short-staffed causes a lack of efficiency and/or productivity for the employer.

The staff scheduling systems in the state of the art can be effective from the employers' perspective. An administrator associated with the employer creates employee accounts, and employees use the scheduling system to communicate ability to work shifts. However, such systems do not provide the employee with a tool to effectively manage all other commitments. By extension, such systems do not provide said employees with the ability to meet their obligations to attend work or other functions efficiently and without stress.

### SUMMARY

According to some embodiments of the present invention, a calendar system is provided that allows a user to create his or her own account, to join or be joined to an organization for staffing and/or scheduling purposes, to use the account for calendar or scheduling outside of the organization, and to retain at least a portion of the calendar database after severing membership with the organization.

According to some embodiments of the present invention, a calendar system is provided that allows a user to indicate said user's availability for work or participation differently for the various organizations to which the user belongs.

### BRIEF DESCRIPTION OF THE DRAWINGS

The invention will be better understood by way of the following detailed description of embodiments of the invention with reference to the appended drawings, in which:

FIG. 1 is a block diagram illustrating the main components and modules present in an embodiment of the present invention;

FIG. 2 is a block diagram prominently illustrating Manager Account 200 and User Account 100 types as well as portions of the data contents and properties of each, in addition to the relationship between said data to some of the main components and modules of an embodiment of the invention;

FIG. 3 is a diagram depicting the relationship and data retention model existing in the prior art between individual members and the organization to which they belong, wherein data proper to said members remains only in the organizational database rather than being accessible to said members after leaving an organization;

FIG. 4 is a screenshot of a user calendar, depicting portions of a particular time period for said user;

FIG. 5A is a screenshot of a user calendar with said user's availabilities color-coded for a specific organization selected via radio button among those organizations listed, and FIG. 5B is a similar screenshot for a different selected organization;

FIG. 6 is a screenshot illustrating a Manager Account scheduler view for an organization scheduler, wherein are shown the event or work shift presence of each user (as a color-coded time range depicted in a relatively thicker band running horizontally), and the potential availability of each user (also a color-coded time range, depicted in a relatively thinner band running horizontally and below the foregoing) when known;

FIG. 7A is a screenshot of user dialog accepting event invitation;

FIG. 7B is a screenshot of an organization schedule for a particular week superimposed with work shift or event time ranges, in addition to icon and color-coded and iconographic symbologies to indicate, variously, whether said event as scheduled has been published and/or viewed by intended attendee.

### DETAILED DESCRIPTION

In the following description, the use of “he” or “she” is not intended to refer specifically to gender, but rather simply to a user of either gender.

A watershed change in the relationship that most humans had with time—and scheduling in particular—arguably began with the industrialization of those humans' respective societies. The social and economic progress brought forth by such industrialization occurred in no small part because of changes to the nature and character of labor during this era. Factories, the main vectors for industrialization, were typically organized around one or several assembly lines, which were often manned by armies of human workers toiling, for the most part, in notoriously unenviable conditions. The governing dynamic was dour though clear: able-bodied though expendable workers typically committed to working long hours in exchange for an often meager wage until they were no longer able, at which point they were replaced.

Evolving historical circumstances prompted shifts in cultural attitudes. With these came changes in labor expectations and worker mobility. Despite leading ever faster-paced lives, a greater importance came to be placed by workers on work-family balance, leisure time, and other personal priorities. While increased productivity remains a key objective to be met, the traditional dynamic described above has been altered significantly, with traditional approaches called into question by all stakeholders, in many cases prompting a broad reconsideration. Indeed, such reconsideration represents a managerial and logistical challenge to many organizations, a great deal of which nonetheless acknowledge that it is necessary and that the benefits justify the effort, if only to appeal to and retain their best employees. Organizations are increasingly seeking to articulate a managerial strategy that is aware, sensitive, and flexible to their members' availabilities and which proposes solutions to help the latter reconcile their own availability for work with their individual non-work commitments and needs. Most employers who adopt such proactive attitudes do so with the understanding that such responsiveness is beneficial for organizational efficiency overall. Many organizations that have embraced a conciliatory managerial approach of this type acknowledge that their challenge lies in recruiting and retaining members committed to the organization's mission, and that ultimately, their organization is only as good as its employees are at fulfilling that mission.

The calendaring paradigm adopted by various embodiments of the present invention involves several functional modules, many of whose operations functionally interconnect. For certain of these operations, such interoperation is characterized by a sharing of specific data; while for others, a data encapsulation principle—in which only that information which is absolutely necessary to share—is applied. The modules that make up embodiments of the invention as well as the manner in which these modules may independently generate and/or process data will be described herein.

Calendaring systems serve to coordinate individuals and events in various situations. An “event” may be broadly understood, in embodiments of the present invention, as the occurrence of any activity or task involving one or more resources and taking place at a precise moment in time. A “resource” in this context generally refers to the availability of a tangible and individual human, although the concept can analogously encompass all manner of movable or immovable things, such as a vehicle, chain saw, projector, football field, office space, or building. The participation of a resource in said activities may be solicited by an individual or by some organization—a party whose relationship or interest to the resource typically exists or is more or less defined. A frequently-overlooked factor in the overall success of many organizational undertakings concerns the organization's sensitivity to the ways in which its own needs overlap with its members' individual and collective capacity—both in terms of ability and availability—both to meet those needs. Very often, such availability is motivated if not altogether driven by members' individual circumstances and particularities. An organization's sensitivity to these factors, in addition to its capacity to promptly adapt to their evolving nature, is key to its success and particularly to its efficiency overall. Accordingly, while events scheduled through a calendaring system may involve or otherwise target a single human participant, they typically depend on the participation of more than one participant. Such participation, as well as the materialization of the event, is a function of the coordination and availability of all resources involved.

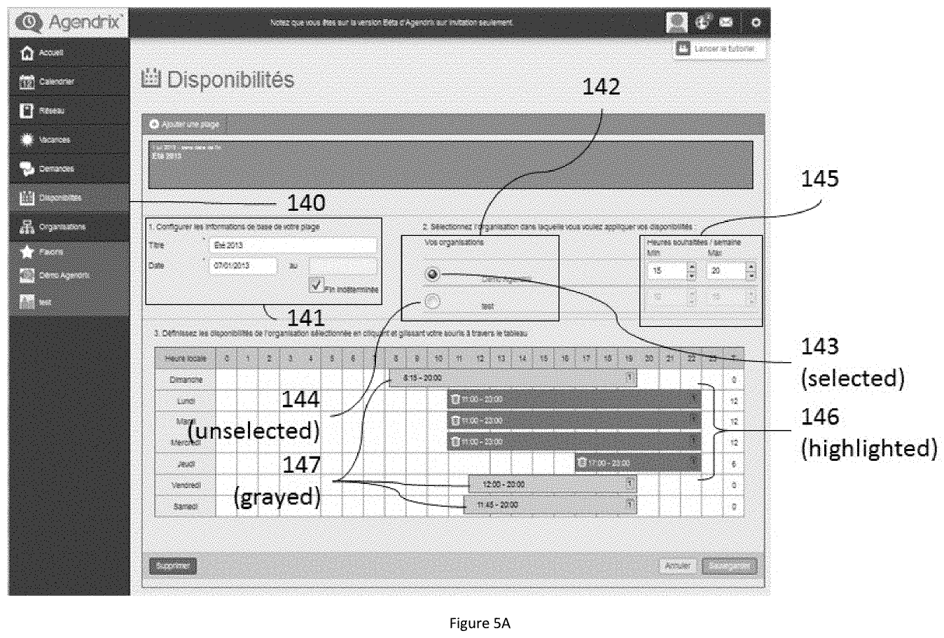

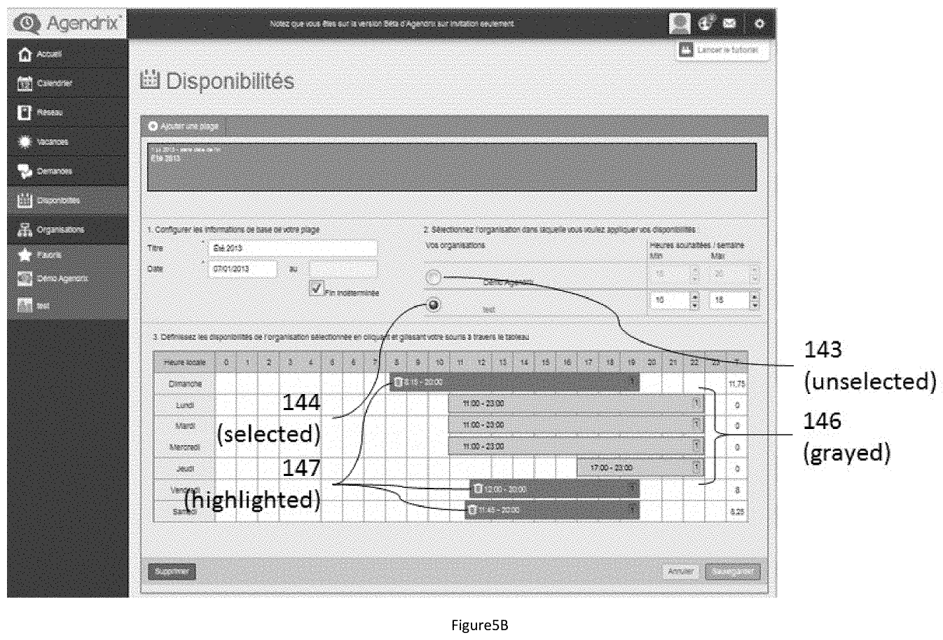

The calendaring system proposed by various embodiments of the present invention supposes a collaborative paradigm in which the overlap or coincident availability in time of resources is sought. For the most part, such resources are directly characterized as human users for a particular event or series of events. The successful realization of this objective is typically subject to the logistical availability of the individuals whose presence is solicited for a given event. Equally central to embodiments of the present invention is the aspect that each individual's availability maybe concurrently governed, in addition to logistical considerations, by non-logistical ones such as personal judgment or other psychological factors which in turn inform the manner in which he may prioritize his availability for a given event. As a result, various embodiments of the invention allow an individual to specify and disclose—with extreme granularity—the blocks of his time 146, 147 that he will make available and/or attributable to different individuals or organizations 142, 143 (FIGS. 5A and 5B).

To this end, embodiments of the calendaring system described in the present invention rely on an adherence to a paradigm that features two distinct but complementary account types whose particularities respond to and broadly mirror the real world attributes and roles played by individuals and organizations. An Account Manager module 350 manages the creation and modification of User Accounts 100 and organization accounts 200, details of which follow below.

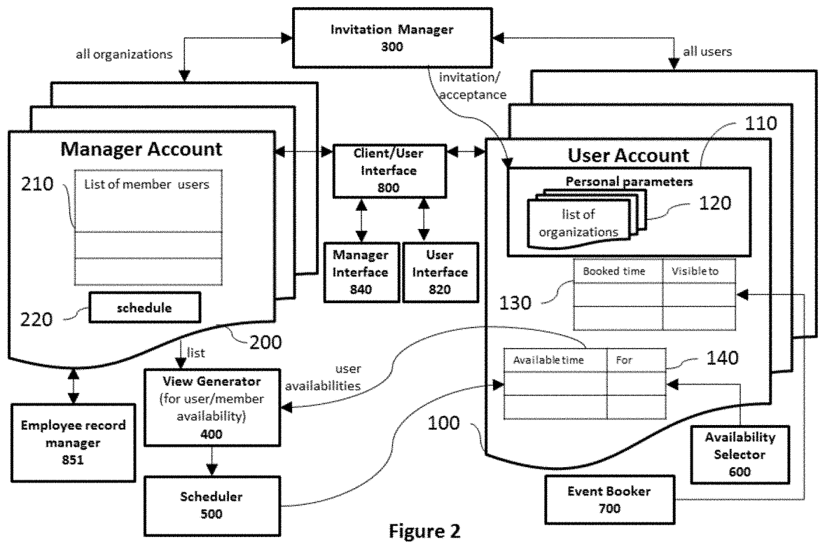

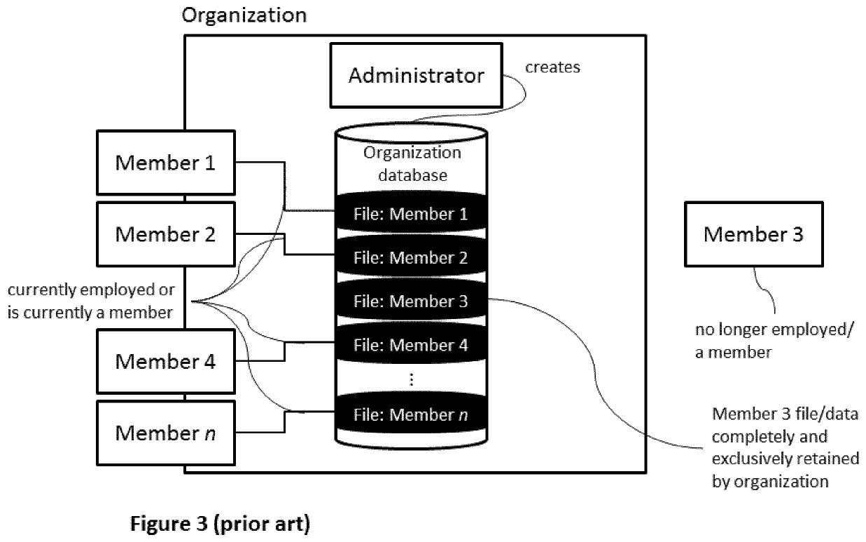

With reference to FIG. 2, at the very heart of the paradigm is the User Account 100. This is the account type created by an embodiment of the invention for the purposes of allowing a human (or other resource) to interact with an embodiment of the calendaring system's functionalities as a potential participant in events. To this end, a User Account 100 may “join”, or affiliate, with one or several organizations in a manner similar to that in which a user may create affiliations on various social media platforms (synonyms for which commonly include “following”, “friending”, “linking”, and “adding”). Further to the social nature of the various embodiments of the present invention, a User Account 100 affiliates with other accounts present and accessible 300′ within the calendaring system. Accounts with which such an affiliation is created, known as “affiliated accounts” 120, 210, may also be of the User Account 100 type, or alternatively represent an organization, whose distinctive Manager Account 200 type particularities will be discussed subsequently. Moreover, the holder of a User Account 100 may present a distinct personal availability set 140, 146, 147 to each of the accounts 120, 143, 144—whether they are other Users or organizations—with which he has established an affiliation. In this way, one User Account 100 representing an employee may be simultaneously affiliated 120, 120′ to one or several Manager Accounts 200, where the latter account holders 201 are administrators representing the same or even multiple distinct organizations or (more explicitly, in several scenarios,) employers. Embodiments of the present invention may be used to communicate each of a User Account 100 holder's availability sets 140 via one or several interfaces (FIG. 5a, FIG. 5b) that communicate with the Availability Viewer module 450, which receives such availability information.

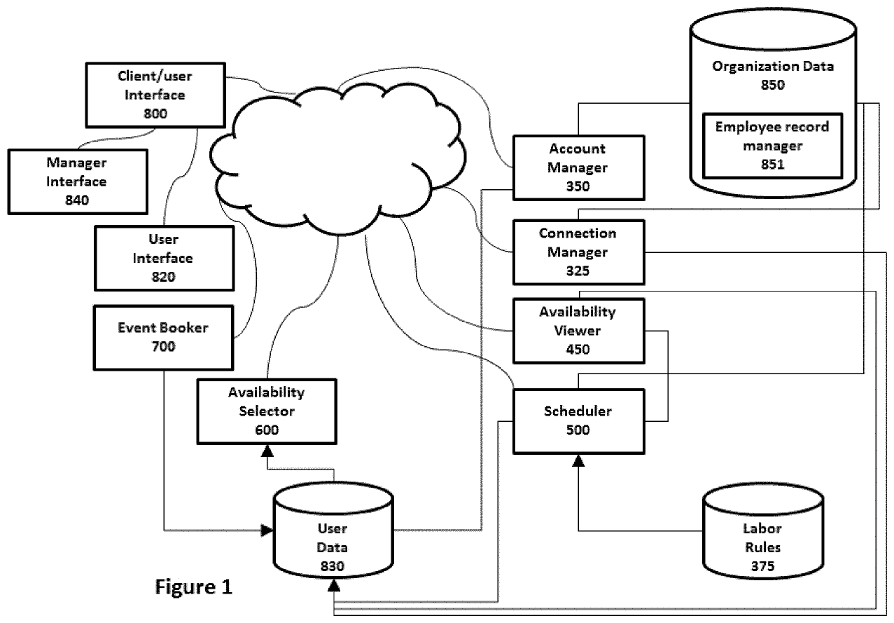

The calendar system of FIGS. 1 and 2 is a computer calendar system and is distributed across different computing devices. Interfaces and modules are typically implemented in software stored in memory for executing by a processor (for example a CPU), although it is possible to configure hardware, such as an FPGA, to perform tasks as well. It will be apparent to a person skilled in the art which components should be co-located at a computer or processor and which components should be located elsewhere on the network. It will also be appreciated that some components can be provided by a client-server model involving an active server and a client app or browser working together. Mobile computing platforms are particularly convenient for users on the go. A working embodiment of components and/or the whole system can also be provided by software stored in a data storage medium.

For the purposes of various embodiments of the invention described herein, an organization is a broad construct that replicates, in whole or in part, one or more aspects of a real-world grouping, structure, or association. Such breadth of scope allows embodiments of the present invention to suit any number of real-world situations in which diverse goals are targeted. Examples of organizations include, without limitation, a large or small employer, a volunteer or non-profit association, an amateur sports league, or any other grouping of individuals united by some common objective or around some mutual need. However, by virtue of its nature, an organization does not typically volunteer its own availability information as would an individual. Rather, an organization is an entity that marshals groups of individual resources—human or otherwise—that are available to it.

The differences inherent in the respective roles of individuals or resources as compared with those of the organizations to which they affiliate is ordinarily reflected in their respective task structures; these distinctions are partially mirrored in embodiments of the present invention by way of distinct account types. Accordingly, a complementary account type known as a Manager Account 200 exists and is intended for use by individuals occupying amanagerial role within a given organization.

A User Account 100 is thus distinguished from a Manager Account 200; the latter serving to administer one or more organizations' scheduling needs while the former represents the potentially distinct availabilities 146, 147 shared with each of potentially several organizations served by an individual or a resource. Nonetheless, the need for an individual to perform administrative duties within one or more organizations may arise; in this case, two main potential scenarios are possible.

In one scenario, an individual required to perform administrative duties for an organization using an embodiment of the present invention may simply and promptly create a Manager Account 200 specifically to manage said organization's scheduling and calendaring needs. This is, in particular, one way in which a first time user of an embodiment of the present invention may found or first establish his organization's account presence. User Account 100 holders may subsequently affiliate 120 with a Manager Account 200 so created in a manner analogous to that in which employees join a company once it has been founded.

In another scenario, an existing User Account 100 holder may be designated, entrusted, or otherwise invested with the role of managing an organization's scheduling needs by an existing Manager Account 200 holder for said organization. In this scenario, the User Account 100 of the individual so designated is granted all the administrative privileges and functionalities available to a holder of said organization's Manager Account 200. Such designation, granting, or conferral of administrative privileges is more abstractly referred to as investiture. In some embodiments, investiture may be subject to an approval process involving existing holders within a given organization. In other embodiments, such as when an individual wishes to create an organization, no such approval is needed, and said individual may execute a menu command available from within the User Interface 820 that allows him to create a Manager Account 200 from within an existing User Account 100 that essentially permit him to carry out dual roles, as described subsequently. Furthermore, in various embodiments of the present invention, an account initially possessing User Account 100 functionalities, affiliated to a given organization, and upon which Manager Account 200 functionality has been conferred for said organization, may optionally retain and continue to simultaneously provide functionalities proper to both User Accounts 100 and Manager Accounts 200. In cases where an account holder is mandated to carry out a dual role, namely when his actions require that he assume duties for one or more organizations while still acting as an individual member of one or more same or other organizations, the corresponding User Interface 820 and Manager Interface 840, further described herein, must be appropriately integrated within his account, accessible to him via the Client/User Interface 800, to fulfill his dual role.

No theoretical limit exists on the number of User Accounts 100 upon which Manager Account 200 functionality for one or more organizations may be conferred in this way. As a result, multiple Manager Accounts 200 may concurrently exist for the same organization. In addition, a User Account 100 holder need not possess prior affiliation history with an organization to be invested with Manager Account 200 privileges and functionalities for said organization. In some embodiments of the present invention, the foregoing may lead to a situation wherein a single account may concurrently possess, on the one hand, functionality associated with User Accounts 100 for those accounts with which said account's holder is affiliated in his capacity as a user, and on the other, Manager Account 200 functionality for those organizations on behalf of which said holder acts as an administrator.

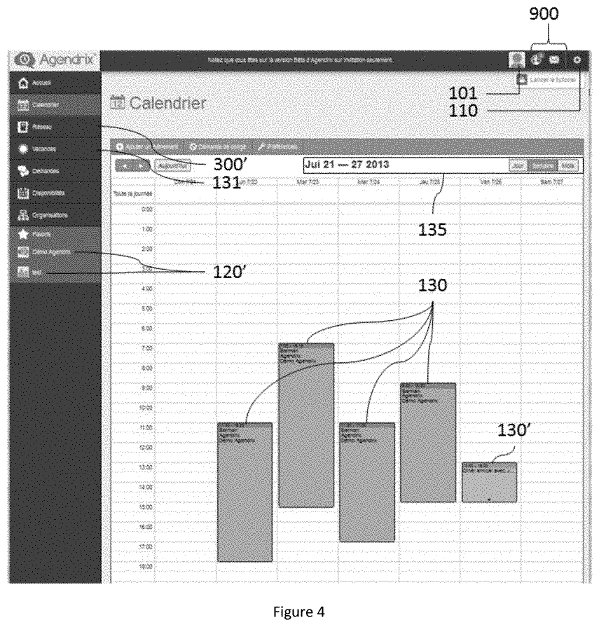

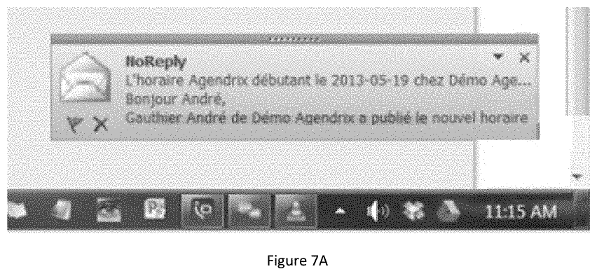

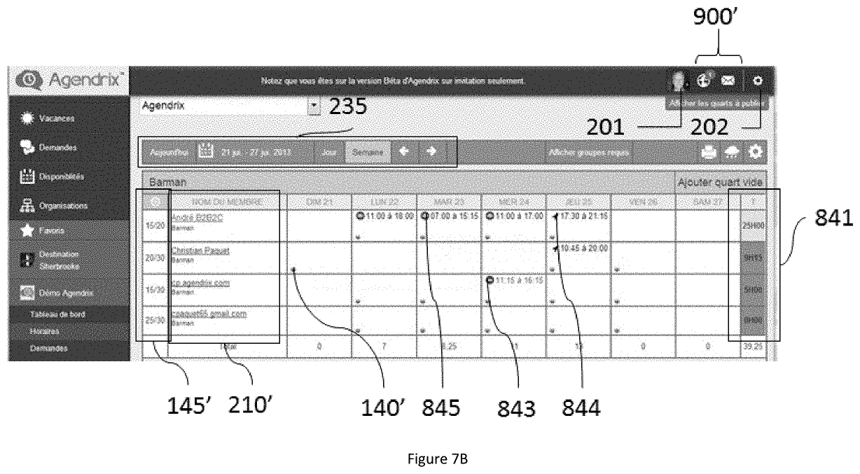

In one example embodiment of dual-account functionality, a small restaurant owner responsible among other things for scheduling employee shifts may, by virtue of this role, assume Manager Account 200 duties. In this capacity, his responsibilities may include creating one or more events, or work shift calendars (FIG. 7b), for his staff. Concurrently, however, he may additionally access User Account 100 functionality which in turn allows him to view, access, modify, and otherwise plan his own personal calendar precisely as would a User Account 100 holder described herein and not appointed with any organizational responsibilities (FIG. 4). Accordingly, in various embodiments, events appearing in said restaurant owner's personal calendar items may, in cases of dual-account functionality, be either fully integrated within, or alternatively entirely separate from the calendar interface in which he manages his shift scheduling management duties for the restaurant 130, 130′. Accordingly, the view and level of integration of each (or both) interfaces may be specified through a menu or slider option available from his account interface 800. Thus, such dual account functionality may provide a possible continuum of integration, from blending both a User Account's 100 and Management Account's 200 functionalities, including calendar data, to maintaining a distinct separation between the two interfaces 820, 840. In either case, both account type functionalities may be accessed within an account session without necessitating a disconnection or subsequent logout/login procedure.

Likewise, an organization administrator in possession of a Manager Account 200 for said organization may divest himself of his administrative responsibilities; he does this by ceding administrative responsibilities to the remaining Manager Account holders 200 within said organization. It will be appreciated that Manager Account 200 divestiture is distinct from disaffiliation: in the former case, a Manager 200-turned-User Account 100 holder's affiliation with said organization endures, whereas in the latter, a User Account 100 holder's affiliation with the organization is severed.

In an embodiment, an account holder may be provided—via one or more methods in a User Interface 820 or Manager Interface 840—with the ability to delete his own account. The underlying functionality and effect of such deletion may be variable, and depend in part on governing legislation. For example, in some embodiments of the present invention, account deletion may entail the irrecoverable erasure of all data relative to said account and held in all data stores of the invention. In other embodiments, account deletion may result in an effective dislocation of an account holder from all aspects having formerly constituted his account presence, but without irrecoverable erasure of data. In such cases, an account holder may no longer be able to complete a logon procedure, nor assume any longer the virtual presence previously afforded by possessing an account. In some embodiments, deletion may allow the retention of some or all of the data created by, associated with, or otherwise held within one or more data stores 830, consistent with data retention policies that comply with applicable laws. In another embodiment, a custom deletion policy may be specified for an account by its own account holder, whether a User Account 100 holder or a Manager Account 200 holder, within the Manager Interface 840 or User Interface 840 respectively. The scope and details of such a custom policy may be so granular as to permit the account holder to specify whether and how each data asset will survive said account's impending deletion. In a further embodiment, a corresponding account undeletion mechanism may be implemented and supplied, allowing a former account holder may resume any deleted account with any extant assets retained as a result of a deletion policy previously put into action for said account, whether such deletion action was accidental or deliberate. Said mechanism may be accessible from any prompt enabling access to an embodiment of the invention, with account reactivation enabled through the correct disclosure of any of several prespecified identifiers, including without limitation, Personal parameters 100, but also including other credentials specifically allocated for this purpose.

In certain cases, it may be desirable to devise rules to govern conditions to satisfy (or alternatively, precedence requirements to observe) for an account deletion to proceed. In one notable example, the sole remaining Manager Account 200 holder of an organization may wish to delete his account. In such circumstances, it may be advisable for an embodiment of the invention to require a prior and complete disaffiliation of all User Accounts 100 from said organization. Such complete disaffiliation may occur via any of several methods. A non-limiting enumeration of these methods may include, for various embodiments of the invention: a natural disaffiliation-based attrition process until said organization's user list 210 is entirely empty, a formal disaffiliation request issued by said Manager Account 200 holder to all accounts said member list 210, or, in at least some embodiments of the invention, by way of a complete member user disaffiliation functionality available to a Manager Account holder 200. For logistical reasons, access to the latter functionality may in particular be limited to an organization's final remaining Manager Account 200 holder, or may alternatively be available to all of an organization's Manager Account 200 holders at any time.

In a subsequent realization of the data encapsulation principle described herein, the deletion of an organization's sole remaining Manager Account holder may preferably involve an intermediary self-divestiture action. Self-divestiture would in such cases most notably favor a distinction in the deletion and data retention policies to be applied—separately and individually—to organization data and user data. The completion of such self-divestiture may, in various embodiments of the invention, be activated either manually by the Manager Account holder or automatically by the embodiment of the invention itself.

For its part, manager Account 200 divestiture may occur, for instance, when an interim manager within an organization returns to his regular and non-management duties within said organization. In this scenario, the former administrator no longer possesses a Manager Account 200 for said organization, but rather a User Account 100 for that organization. Likewise, Manager Account 200 divestiture also occurs, for example, when a restaurant manager responsible for scheduling is terminated or resigns his position; irrespective of the circumstances surrounding his departure, he ostensibly leaves the organization as a result. In this case, disaffiliation occurs in addition to divestiture.

In this same vein, a User Account 100 may be disaffiliated from an organization to which it was previously affiliated. Such disaffiliation may occur on the initiative of the User Account 100 holder, or may instead be carried out by a Manager Account 200 holder within the organization from which said disaffiliation occurs. A User Account 100 may also disaffiliate from any User Account 100 with which it is affiliated.

The various situational circumstances that underlie the use of embodiments of the present invention to carry out account affiliation and disaffiliation can certainly be appreciated for their immediate logistical motivations alone. However, an additional element may be appreciated when considering an embodiment of the invention on a wider scale, over a longer term, and with a view to promote its use. It is noteworthy that the real-world socialization patterns both mirrored by and realized through account affiliation present an opportunity to propagate an embodiment of the invention itself via an essentially organic and ongoing viral marketing campaign. Accordingly, two major avenues are discernible through which awareness of an embodiment of the invention may be raised and from which its adoption among a growing user base may be fueled.

One such opportunity occurs in the case where an individual joins an organization that already makes use of an embodiment of the invention in the course of its activities, and in which said individual is encouraged to create a User Account 100. The conjugate scenario likewise presents an opportunity, whereby an existing User Account 100 holder acts as a vector for subsequent growth. In this scenario, said User Account 100 holder later joins one or more organizations previously unaware of an embodiment of the invention, and in a manner comparable to an ambassador, advocates or otherwise provides the impetus for the latter's adoption. Aspects and scenarios pertaining to the viral growth of various embodiments of the present invention are further discussed herein.

User Accounts 100 and Manager Accounts 200 are created by the Account Manager module 350. Account creation is required to obtain a presence within one or more embodiments of the invention, and includes instantiating and populating the data structures appropriate to either account. The contents of certain of these data structures, such as personal parameters 110—including, without limitation, account identification, contact information, time zone, and related properties—maybe specified by the individual creating the account at the time of account creation and anytime thereafter, as needed. This may typically be done by entering data via one or more human interface devices into fields designated for this purpose 800 and accessible via a graphical interface. In certain embodiments, certain data structures involved in the creation and subsequent maintenance of an account may operate with varying degrees of autonomy or outright independence from data specified by the user for the purpose of creating the account. Such operation may include, without limitation, communication with one or more modules external to the Account Manager 350.

In addition to changes made to personal parameters 110 of an account by said account's holder, modifications may be made to the fundamental nature of an account itself and require some interaction from other accounts. The Account Manager 350 also handles such modification tasks. A leading example of this type of modification—described in greater detail herein—is investiture, or its counterpart, divestiture, processes by which a User Account 100 respectively gains or loses Manager Account 200 functionality. Such modifications are distinct, for example, from those changes made to an account's personal parameters 110, in that the former occur at the behest of a separate account holder. Accordingly, the Account Manager 350 module's involvement in such modifications is necessary, but it is not the only module involved in such operations.

Collaboration with other modules is typically necessary to bring about several types of modifications. For example, investiture or divestiture operations require modifying an account holder's access rights to data stores that were previously inaccessible or accessible, respectively. The Account Manager module 350 also participates in ascertaining the precise user interface layout to present to each account holder by variously communicating account particularities with the Manager Interface 840 or the User Interface 820 module and occasionally, as in the case of investiture, with both of these. Data is exchanged between the Account Manager 350 and the latter two modules on an ongoing basis in response to changes in account status.

The Connection manager 325 module is central to the operation of various embodiments of the invention. Chief among this module's tasks is its primary and direct involvement in the establishment and completion of affiliation and disaffiliation operations between accounts. The graphical interface of a User Account 100 or a Manager Account 200 typically includes functionality 300′ to initiate and establish affiliation with another account. This functionality may be implemented via any of several means. In at least one embodiment, affiliation may be initiated following a global or partial directory lookup of members via any identifier that has been shared by a target account holder for this express purpose. Such an identifier may be provided to an embodiment of the present invention using any one or several human-interface devices, including, but not limited to, a keyboard, a mouse, a microphone, or a camera. As a non-limiting example, such identifiers might include part or all of any of the following parameters of the target account: its handle or identifier, the account holder's name, email address; other contact information, for example, the name, surname, corporate name, or any other account property that has been shared publicly for the purpose of establishing account affiliations.

An affiliation request is typically issued once a target account holder has been identified by a source account holder and an invitation sent to the target by the Invitation Manager module 300. The Invitation Manager module 300, in its capacity as a specialized component contained with the Connection manager 325, can access all account identifiers for all accounts created using an embodiment of the present invention, and can issue an affiliation request to a remote account holder. The Invitation Manager 300 does this once it has determined that said remote account holder exists and is not already affiliated to the local account. An affiliation may be established between two users having the same account type (e.g. users to be affiliated are both User Account 100 holders) or both parties may be of opposite account types (e.g. a User Account 100 holder affiliates with a Manager Account 200). An affiliation request may be accepted or rejected by the targeted party. In the latter case, some embodiments of the invention may allow for the target recipient to supplement his affiliation rejection with a written message and/or allow him to record a video or audio message to this effect 900. On the other hand, an acceptance may follow from the target user instead of a rejection, prompting a successful completion of the affiliation process. Once this occurs, the two accounts thus affiliated may mutually view the other's shared information, including any shared personal identification parameters.

The information that a local account holder may view about an affiliated and remote account varies, and is primarily a function of whether the latter is held by a User Account 100 holder or a Manager Account 200 holder. If the remote account is held by a User Account 100 holder, then shared identification and calendaring information-such as data availabilities 140, booked time 130, and minimum, average, maximum, or cumulative time commitment values 145 based on the sharing policies determined by said holder—are shared. If the remote account is held by a Manager Account 200 holder, the local account holder will view only limited shared information determined by the former, such as identification properties. If the local account holder is in possession of a User Account 100, he may nonetheless be able to view any time booked by said organization, albeit within the former's own calendar view. Typically, a User Account 100 holder will affiliate with organizations or with other individuals, according to his interests and commitments.

In various embodiments of the present invention, a User Account 100 typically consists of several elements (FIG. 2). These include a Personal parameters 110 section which contains, without limitation, identification, contact information, and settings preferences which includes preferred methods by which to solicit the account holder. A complete list of organizations 120 and other User Accounts 100 with which said User Account 100 is affiliated is also included. A User Account 100 also maintains various types of calendar data and metadata, which will be discussed imminently.

One such data type is Available Time 140, which corresponds to a listing of times and dates during which the User Account 100 holder may be solicited for participation in an event. This type of calendar data is notably subject to encapsulation, as different sets of Available Time 140 data may be specified and presented by the User Account 100 holder to different affiliated accounts differently. Such sets may even be non-overlapping, per the preferences and sharing policies specified by the User Account 100 holder.

A second type of calendar data property of a User Account 100 is Booked Time 130, which corresponds to a listing of all the calendar dates and times of events to which a User Account 100 holder's participation is committed (FIG. 4), and in various embodiments of the invention may be alternately viewed by day, week, or month 135. Booked Time 130 frequently consists of time windows previously drawn directly from a User Account 100's Available Time 140 windows 146, 147. However, in certain embodiments of the present invention, a User Account 100 holder may designate time windows on his own initiative as Booked Time 130, without having previously received a solicitation. In addition, the visibility of Booked Time 130 data is subject to similar encapsulation principles as Available Time 140, as none, some, or all of a User Account 100 holder's Booked Time 130 listings may be rendered visible, consistent with his settings preferences, to none, some, or all of his affiliated accounts 120.

It will be appreciated, in light of embodiments, deployments, and implementations discussion herein, that strong encapsulation between organization and user actions and privileges is desirable. However, strict encapsulation need not necessarily be contemplated for all implementations described herein. Furthermore, a nuanced application of encapsulation principles disclosed herein can be advantageously applied to yield robust functionality. Thus, a situation can be envisioned in which an aspect of such strict encapsulation can be overridden where a user affiliation with an organization exists. In certain implementations, a User Account 100 holder can specify his Available Time 140 windows 146, 147 as disclosed herein. However, it may likewise be acceptable for the Manager Account 200 holder of an organization to specify and input a state of availability for a specific User Account 100 holder affiliated to that organization. Such actions and related functionality can for example be particularly useful in cases where an employment agreement stipulates that an employee will be available for a specific employer at given times, at specified frequencies, or even upon (the employer's) demand. It is contemplated that such overriding can be accompanied with notification indicating that a specific availability set 146, 147 has been modified by way of overriding by an external party. As an example, a supervisor can specify a shift schedule consisting of required availabilities for a specific employee affiliated to the workplace or organization. In a further scenario, mechanisms by which a User Account 100 holder can oppose such external overriding—whether as a general policy, or directed toward a specific instance thereof—can be further supplied to the User Account 100 holder. In a still further deployment, functionality enabling opposition, such as by an employee to notification of such an imposed availability set, can be absent. In such cases, procedural and interface steps pertaining to an employer obtaining approval of an employee to imposed availabilities upon him as specified by an employer can be abrogated.

In another embodiment of the present invention, it is additionally possible for a User Account 100 holder, or alternatively an individual having dual User Account 100 and Manager Account 200 functionality as described herein, to create, specify, and book, within his own User Account 100 calendar, one or more events not necessarily associated with any organization of which he may or may not be a member. Said event(s) and related calendar data assets are subject to data encapsulation principles further described herein, the visibility of each may accordingly be restricted to said individual alone, or variously extended to include or exclude a theoretically non-limited pool consisting of other User Account 100 and/or Manager Account 200 holders, whose accounts may 120, 120′, 300′ or may not be affiliated with said individual. In addition to the foregoing, said individual may, in another embodiment of the present invention, further invite any or all members from said pool to event(s) not associated with an organization.

The modalities whereby time windows deducted from a User Account 100 holder's Available Time 140 pool are transferred to his Booked Time 130 pool may differ according to the booking policy settings, also specified in his account's personal parameters 110 settings. In various embodiments of the invention, possible booking policies available to a User Account 100 holder may be viewed as forming a continuum between, on the one hand, booking notification—in which an event is always assumed to be automatically accepted (with such acceptance considered final by default)—and on the other, booking solicitation—in which each event's acceptance is indispensably conditional to its recipient's approval.

In some embodiments of the present invention, extremities in the booking policy continuum just described may be subject to additional constraints or freedoms. As a non-limiting example, event solicitations occurring in whole or in part within time windows outside those specified by a User Account 100 holder's Available Time 140 data may be automatically accepted or rejected by said holder's account; alternatively, an embodiment of the present invention may issue a notification 900, prompting him for a decision in each case. The actions to take in such instances may be specified within a User Account 100 holder's Personal parameters 110 page.

Nonetheless, if a User Account's 100 Available Time 140 information does not indicate that he is available to participate in an event, an affiliated User Account 100 or Manager Account 200 may, nonetheless, in an embodiment of the invention, issue an invitation 900 to him, cognizant that said invitation may rationally be declined. In another embodiment, an unaffiliated User Account 100 or Manager Account 200 holder may be provided similar functionality and constitute an equally permissible inviting party. The purpose of said invitation, which may be issued via any of the notification mechanisms described herein, is for the inviting party to unambiguously ascertain the targeted User Account 100 holder's availability for said event occurring outside the latter's stated, shared and/or otherwise apparent Available Time 140 window(s). Alternatively, although there is no explicit expectation of acceptance, one or more aspects of said invitation may be of such a nature as to prompt an otherwise typically unanticipated response in the form of a priority change on the part of said target User Account 100 holder, such that the latter may subsequently adjust, including without limitation, his own calendar data through any mechanisms, including without limitation those described herein and which are functionally, permissibly, or otherwise available to him. Thus, if a User Account 100 holder has not indicated availability 140 for a given time window, it is still possible for the Manager Account 200 holder 201 of an organization to invite 900′ the former 100 to extraordinarily book time 130. If an individual, for example, is available to volunteer for a charity event on a Sunday evening 140′, this functionality would accordingly allow a Manager Account 200 holder for said charity to attempt to secure the former's time for a Wednesday evening, either additionally or alternatively. Similarly, this same functionality may be invoked to potentially implement any other sort of amendment or modification, such as lengthening or shortening a work shift already scheduled 844, 845.

In further implementation, a Manager Account 200 holder can offer a particular shift to be filled to any number of possible employees (i.e. affiliated User Account 100 holders). In such a scenario, the Manager Account 200 holder can non-limitingly be imagined to be a shift manager or other schedule coordinator 201. Furthermore, such a Manager Account 200 holder and/or schedule coordinator 201 can be imagined to operate or manage an organization such as a restaurant or other organization at least partially dependent on shift-work. Employees can be made aware of the existence of such a vacant shift by way of a notification issued by a manager Account 200 holder. No specific limitation as to the employees to target for such shift notification is envisioned. Accordingly, one, some, or even all employees can be made aware of such a vacant shift by issuing the notification to any number of them. Accordingly, a User Account 100 holder having received such a notification can positively respond to it by signaling acceptance of the specific shift described within the notification. Following such acceptance, the shift correspondingly appears the User Account 100 holder's Booked Time 130 listing, as well as through the Manager Account 200 holder's Manager Interface module 840. In this way, a manager or coordinator 201 can thus signal the availability of, and accordingly offer, one or more specific shifts to any of specific employees. No specific limitation is contemplated with regard to the functional variations on the aforementioned scenario. Thus, notification issuance scenarios and acceptance mechanisms can vary. For example, a shift can be awarded in accordance on the basis of a first-come, first-served policy (i.e. the first employee to accept such a shift notification is awarded the shift), with no further logistical, management, or negotiation efforts required. Alternatively, one or more complex or preferential mechanisms, whether automated or manual (e.g. involving the discretion of a Manager Account 200 holder) can be envisioned.

Potential or existing scheduling conflicts may also be governed through a policy specified and configured by a User Account 100 holder. Without limitation, various embodiments of the invention may allow a policy to be set whereby the User Account 100 automatically accepts or rejects any conflict that arises. Alternatively, a notification 900 may be sent to the User Account 100 holder, prompting him to manually resolve conflicts in a manner he deems appropriate. As a non-limiting example, such conflict management policies may apply to all potential conflicts affecting a User Account 100, or to conflicts originating from or involving only certain affiliated accounts.

In another embodiment, a User Account 100 holder may specify that his availability as expressed in some, any, or all Available Time 140 windows as being conditional upon the presence or absence of one or more other account holders of any type with which he may be variously affiliated or not affiliated, with such conditional data being further subject to data encapsulation principles described herein. As a non-limiting example, a User Account 100 holder may use such functionality to signal his availability or willingness to participate in an event that includes or excludes, without limitation, one or more of a set of participants, friends, or resources during one or more specified time intervals, while defining one or more different intervals to similarly include or exclude a different set of participants. Such data may define a state of availability and can also include information defining specific preferences or conditions, further described herein.

In some embodiments, a third major calendar data property featured in a User Account 100 is a set of condition values representing the minimum, maximum, and ideal requested cumulative time commitments 145 which its holder wishes to make or is otherwise seeking to pledge to various affiliated accounts 142 over a given period 141. These values, which in various embodiments of the present invention may be specified separately from the other types of calendar data described previously, represent the minimum, ideal, and maximum amounts of time (expressed in hours, minutes, or any other unit) that a User Account 100 holder is able or willing to be obligated toward one or several affiliated accounts—whether organizations or other users—over a specified time interval.

In some embodiments of the present invention, the set of cumulative time commitment values 145 may be reckoned through any of several formulas, which consider, as a non-limiting example, all or portions of the booked 130, 130′ or available time 140, 146, 147 previously described; other formulas may be entirely user-specified. In some embodiments of the present invention, these values may consist of a group of data fields 145 whose values are specified as a result of the User Account 100 holder's own judgment. While its scope is much broader than the booked and available time windows described previously, this metric is nonetheless useful in various circumstances.

In another embodiment, a User Account 100 holder may additionally specify, for each account with which he is affiliated, one or more lists in which he enumerates conditions in the form of one or more tasks that he variously prefers and/or dislikes performing in the course of his commitment to said affiliated account. The degree to which an embodiment of the invention's interface allows him to express such a list of items and the corresponding relative level of preference for each item may vary and in a non-limiting manner may include interface elements ranging from a simple editable text field to an editable list box or combo box, with relative preferences for each item being expressed, for example, via a set of radio buttons or a slider for each item made to represent positive and negative extrema. Preference information so expressed may be further rendered sortable according to a particular rank or order. Furthermore, said User Account 100 holder may choose to share such a list with a Manager Account 200 holder in accordance with sharing properties specified in the former's Personal parameters 110 section. Said User Account 100 holder may further limit the application of such preference listings to a specific time window or instead globally apply them to all time windows visible to a given affiliated account. Such information is intended to assist said Manager Account 200 holder in planning and apportioning tasks, in addition to affording the latter an opportunity to appreciate the various preferences and aptitudes of his organization's members of which he might not otherwise be aware. In another embodiment, similar information may be shared not only with Manager Account 200 holders of organizations with which an affiliation exists, but also with User Account 100 holders with which an affiliation exists.

For example, a general idea of the number of hours per week each restaurant employee seeks or is able to commit to the organization 145 provides added insight to said restaurant's staff schedule coordinator 201 when contemplating various possible staffing scenarios for a given week or other timeframe. Preliminarily, this insight allows the schedule coordinator to better balance the establishment's staffing needs by first assessing the respective commitment abilities of each employee 145′ before undertaking a thorough study of his entire employee pool's availability details and devising a weekly work schedule accordingly (FIG. 7b). Knowledge of relative task preferences also helps him 200, 201 better manage his varied staff 210′ by allocating overall tasks in a manner suited to said staff's individual and collective preferences, as well as to avoid conflict, to the greatest possible extent. It also helps him avoid inadvertently overbooking 841 an employee who can only commit 145′ to a few hours of work during a given time period despite said employee's having presented numerous or separate available time windows, the total hourly sum of which may nonetheless potentially exceed the specified cumulative time commitment value that said employee may have specified for said organization during said period. In addition, the distinction between the participation conditions of average and maximum time commitment values 145, 145′ convey invaluable information to said manager such that he might appreciate, for example, that although a given employee might prefer to work only 8 hours within a given 20-hour availability window 140, that said employee is nonetheless prepared to work 10 hours within said window if need be. In the same vein, an employee may additionally specify preferred time ranges for participations in an event; for example, he might be available to work any weeknight but particularly prefer to work (or alternatively not work) one specific day of the week and may wish to specify this condition as such. Additional conditions defined as part of the availability state may include remuneration amount for said event during one or more specified availability windows and even for other periods not explicitly defined in an existing or shared availability window. Finally, this insight allows the schedule coordinator to devise a shift-work schedule (FIG. 7b) for a given period 235 in such manner as to favor one or more productive and dependable employees whose availabilities and priorities are known to better line up with the organization's needs, rather than solicit other employees whose performance or availability profile suggests a wavering commitment to the organization or, more broadly, rapid-turnover employees who prejudice the overall organization as a result.

Calendar data encapsulation principles apply to the set of condition values representing the minimum, maximum, and ideal requested cumulative time commitments 145; in a manner analogous to the Booked time 130 and Available time 140 information, a User Account 100 holder may share one set of time commitment values universally among affiliated accounts or alternatively specify a different set of time commitment values to be shared each affiliated account. Furthermore, this value may vary from one time period 141 to the next. A similar data encapsulation policy exists with regard to preferred time range participation.

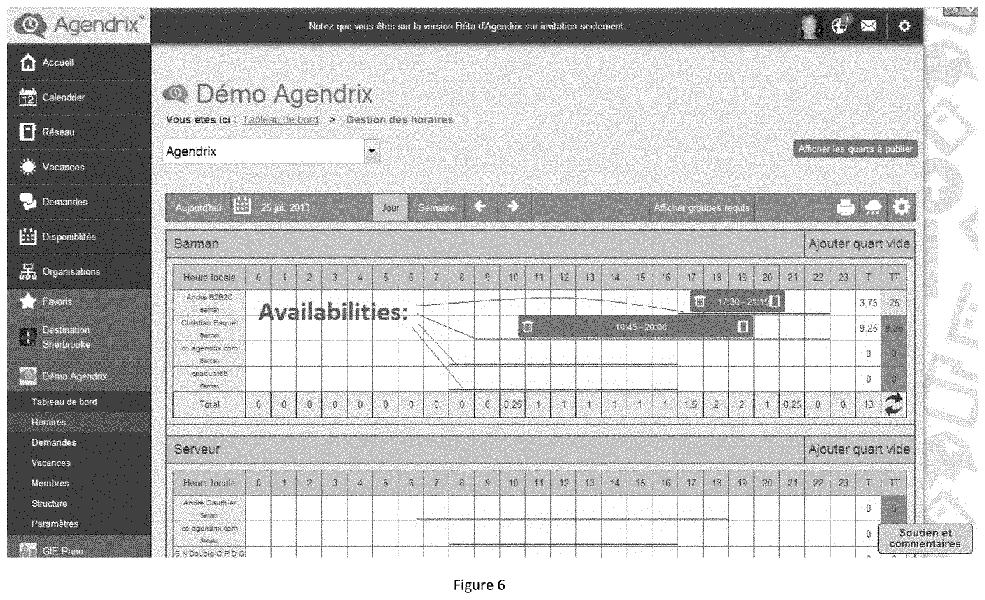

While a User Account 100 possesses a list of organizations 120, 120′ of which said User Account 100 holder 101 is a member, a Manager Account 200 for an organization contains a list 210, 210′ of each User Account 100 that has joined said organization. Just as there is no limit to the number of User Accounts 100 that may affiliate with an organization, there is no limit to the number of Manager Accounts 200 that may administer it. A schedule 220 of all events coordinated by the organization of which the Manager Account 200 holder is an administrator is maintained in various embodiments of the invention and presented to the Manager Account 200 holder when his account is accessed (FIG. 6, FIG. 7).

The accounts paradigm just described groups several different modules, descriptions of whose particular functionality follows. The network diagram illustrated in FIG. 1 helps appreciate the functional and modular relationships between these account types and the remainder of the calendar system described herein, as well as the important information encapsulation principle that characterizes relationships between account types.

A User Data module 830 stores information corresponding to each existing User Account 100 created using an embodiment of the present invention. Such information may include said account's Personal parameters 110 and settings, a complete list of organizations 120 to which said account's holder is affiliated, as well as the potentially multiple and distinct sets of Booked Time 130, Available Time 140, and cumulative time commitment data that said account holder may have specified for and variously shared with the accounts with which he is affiliated.

In an embodiment of the present invention, data in addition to the foregoing may be stored by a User Account 100 holder within the User Data module 830. As with the foregoing, this data is accessible to the User Account 100 holder. It may be transmitted to an embodiment of the present invention by the user and stored in various text, audio, or video formats. This data may be presented, accessed, and laid out in various ways, and be subject to a data encapsulation and sharing policy among other affiliated accounts that is distinct from but akin to that governing calendar data. As a non-limiting example, such additional data may be combined to afford a blog-like functionality to the User Account 100 holder, allowing content to be created, updated, and maintained by him. The entirety of a User Account 100 holder's user data may be physically (or even logically) stored within a single data store or be variously divided among multiple data stores further to optimization considerations.

A similar data store, referred to as an Organization Data module 850, holds information proper to each organization in a manner analogous to that described for the User Data module 830 above with respect to User Accounts 100. However, the contents and operation of the Organization Data module 850 are characterized by certain distinctions as compared with those of the User Data module 830. Several Manager Account 200 holders may simultaneously share administrative responsibilities for a given organization. Also, since Manager Account 200 holders in their administrative capacity may variously join or leave an organization, data held within this module is shared by default amongst all current Manager Account 200 holders currently affiliated with said organization.

Organization Data 850 is thus accessible to users holding a Manager Account 200 for that organization and may include information collected and contributed by an organization's current or previous Manager Account 200 holder(s). The precise contents and scope of the information to be stored within the Organization Data module 850 may vary so as to respond to the individual needs of each organization. Such information may concern any or all User Account 100 holders currently or previously affiliated with said organization. Further to the information encapsulation principle mentioned previously, such data is accessible to an organization's Manager Account 200 holders only and not necessarily the User Account 100 holder(s) about whom the data may concern.

A non-limiting example of content included within the Organization Data module 850 is the compilation and maintenance of employee record data or notes 851, whose purpose is to manage and track the performance of each employee within an organization. Such data might include a report summarizing incidents involving an employee, or alternatively chart employee progress and/or performance with a view to rewarding said employee.

In addition to managing and storing information akin to an individual employee's record 851, accumulated and empirical knowledge about the performance and compatibilities of various combinations of current or past employees—equally valuable to the running of an organization—may also be held in the Organization Data module 850. Additionally, other sensitive information not specifically concerning one or more affiliated User Account 100 holders may be contained in the Organization Data module 850 as well. Thus, in certain embodiments of the invention, this module may simply contain written notes collected by an organization, while in other embodiments, its contents may constitute a complete store of meaningful strategic, analytical, or competitive information forming the basis of an organization's business intelligence.

An important effect of Manager Account 200 divestiture is that an organization's data is only visible to the remaining pool of Manager Account 200 holders for a given organization, and not to any former Manager Account 200 holders divested of an administrative role within said organization. Data encapsulation principles apply to the Organization Data module 850, as only existing Manager Account 200 holders may access the data proper only to the organizations of which they are administrators. Such access rights are lost following Manager Account 200 divestiture occurring as a result of any of the situations described previously. This particularity applies even to data created or otherwise contributed by a divested Manager Account 200 holder to the Organization Data module 850.

However, in certain embodiments of the present invention, this deliberate limitation may be moderated somewhat by enabling access by a Manager Account 200 to a dedicated User Account 100-like data store. A Manager Account 200 supplemented in this way may thus allow its holder to collect text, audio, video, or other data just as might a User Account 100 holder, and subject any or all of said data to a sharing policy similar to that articulated for User Data module 830 despite his occupying an administrator role. The retention of organizationally relevant information in the Organization Data module 850 by said organization following the departure of one or more User Account 100 and/or Manager Account 200 holders is useful. Inasmuch as such retention is consistent with applicable legislation, it may prove invaluable when the Connection manager 325 module re-affiliates a previously disconnected member (as may happen, for instance, when a student returns to volunteer for the same NGO each summer).

The retention of Organization Data 850 makes it possible for an administrator 200, 201 to readily and unmistakably identify returning (or potentially returning) members 100, 101, with data fetched from the Employee record manager 851, further described herein. This feature is particularly beneficial for organizations characterized by a high volume—and especially turnover—of members, since it allows an administrator 200, 201 to recognize the return of historically productive (or troublesome) members whose previous affiliation with the organization may even predate his own. In addition, such identification, both alone and as a part of an embodiment of the invention's capacity to recall employee record data, greatly facilitates the subsequent formulation of accurate statements when requested. This is particularly helpful, for example, when an employer wishes to validate information provided by a potential candidate regarding the latter's previous involvement with an organization, or conversely when formulating an accurate recommendation of a candidate to be forwarded to a different organization. Such information may include, without limitation, the start and end dates defining the period during which a User Account 100 holder was a member of an organization, in addition to other statistics such as hours worked, assiduousness, and other details, as permitted by applicable legislation.

In addition to the foregoing, specific and detailed records on individual employees' performance may be contained in the Employee record manager 851. For example, one or more Manager Account 200 holders for a given employer may create and maintain detailed records, including minutiae determined to be relevant by the organization. In some embodiments of the invention, a custom interface by which to submit employee record data may be assembled by Manager Account 200 holders of a given organization. Said interface may further be constructed from a palette of interface elements, accessible from a menu within the Manager Interface 840, further described herein, with various combinations of said elements integrated to form a custom arrangement that meets the record-keeping wishes and needs of said organization. Once constructed, said interface may be accessed via another menu, also accessible from said Manager Interface 840. As a non-limiting example, aspects included for record-keeping may include such elements of employee performance as punctuality, behavioral incidents, productivity, and absenteeism. Furthermore, if it is deemed organizationally pertinent, an employer may keep such records with extreme granularity, including without limitation, for each employee, including for each shift worked by said employee. Additional circumstantial information in addition to date and time may accompany said records. Thus, in addition to merely logging that a specific employee arrived late to a shift on one occasion, an administrator may, for example, record the specific shift to which said employee arrived late, the specific facility at which the incident occurred, specific work that should have been carried out during said shift, as well as additional circumstances such as any disciplinary action that was taken and logistical repercussions occurring as a result of said late arrival. Subsequent consultation of said employee's record 851 by Manager Account 200 holders of the organization would accordingly show the detailed circumstances of said incident and facilitate tracking instances of recidivism. In a similar manner, more positive aspects of employee performance may likewise be investigated for purposes of positive reinforcement, such as for promotions, raises, recognition, or other benefits.

In addition to accepting information from an organization's Manager Account 200 holders regarding said organization's employees, an embodiment of the invention may also conversely include corresponding functionality whereby a User Account 100 holder may maintain his own records with regard to his experience within a given organization. Such records may include, without limitation, positive experiences, personal performance milestones, or grievances concerning various fellow members or organization administrators in particular. Whereas the Employee record manager 851 may conceptually and even modularly constitute one part that in some embodiments of the invention may be contained within an Organization Data store 850, further described herein, the foregoing analogous records that may be maintained by User Account 100 holders in various embodiments of the invention are typically subject to fewer rigorous management and formatting requirements and thus may simply constitute one of several aspects contained within the User Data store 830, also further described herein.

Likewise, the ability of a User Account 100 holder to retain his own User Data 830 assets following his disaffiliation from an organization confers a tangible incentive toward his continued use of an embodiment of the present invention. These assets 830 may consist of any number of individual items, and include, without limitation, one or more sets of calendar data that has been specified by said individual 100. Furthermore, said User Account 100 holder may have previously assigned a distinct sharing policy for each of these assets 830 among the groups 120 with which he is affiliated. It will be appreciated that the retention of the User Account 100 holder's said assets 830 by said user 100, in addition to leaving intact his previously specified sharing policy as applied to each asset 830, offers an evident advantage and clear incentive for his continued use of an embodiment of the present invention following disaffiliation from an organization. More explicitly, none of said User Account 100 holder's assets 830 involved or otherwise associated with any and all remaining affiliated accounts 120 will be deleteriously affected by the disaffiliation. This individual advantage, together with the overall usefulness and desirability of other functionalities possessed by an embodiment of the present invention described herein, may in several cases motivate said User Account 100 holder to promote and encourage adoption of the same or a variant embodiment of the present invention upon his subsequently joining a new organization unaccustomed to or otherwise unaware of said embodiment(s). Said organization, along with future member peers, may benefit in turn from similar advantages; the scale of such benefit is exponential, particularly following adoption of an embodiment of the invention by—and proliferation within —various other organizations of which each future member peer is further and respectively a part. Organizations such as those in the food services and retail sectors in particular, and more broadly, those belonging to industries that rely on unskilled labor and which employ temporary workers and students, are known for their extremely high turnover. In addition to turnover as a phenomenon posing an already important logistical and financial challenge within such industries, the frustration, misunderstandings, and subsequent fallout from manager error and/or employee carelessness is often likely to exacerbate the frequency, severity, and occurrence of any resulting hardship. Incidentally, workers demographically associated with this phenomenon are among the most suitable candidates for propagation of an embodiment of the present invention through a viral marketing campaign. Thus, the ongoing spread and viral adoption of embodiments of the present invention among new individuals and organizations is continuously endorsed by benefits to the user as well as to any organization with which he may come in contact.

The foregoing adoption pattern of an embodiment of the present invention may indeed be set in motion entirely on the social initiative of a User Account 100 holder. However, in at least one embodiment of the present invention, said pattern may be complemented by a formal though ideally tactful viral marketing initiative. Upon account creation, each User Account 100 holder specifies Personal parameters 110 data including contact information consisting of channels through which he may be reached, in addition to whether he consents to being contacted by the party responsible for managing and administering an embodiment of the present invention itself. The above-mentioned initiative entails, consistent with governing legislation and the latter's 100 prior consent, determining which User Account 100 holders of an embodiment of the present invention to contact. The suitability of candidates for such a marketing initiative may be determined, without limitation, from a central listing of all disaffiliations completed by an embodiment of the present invention logged by the Connection Manager 325 and having occurred within a specified time window. Further refinement of User Accounts 100 to target may be made, and multiple marketing campaigns, each having specific objectives and frequencies, may be devised and executed concurrently or nonconcurrently as a result. Further to such objectives, the precise nature and formulation of any and all contact with a User Account 100 holder can vary and may include, without limitation, positive and encouraging language wherein a reminder of the benefits of the embodiment of the present invention is summarized within a message. Said message may conclude with language encouraging the user, if he has since become a part of a new organization, to complete an affiliation with said organization. Should affiliation not be possible because said organization lacks a presence within an embodiment of the present invention, the targeted User Account holder 100 may be exhorted to invite said organization to establish such a presence and adopt an embodiment of the invention for regular use. Such contact may, without limitation, occur via text/SMS message, email, prerecorded telephone message, or through User Interface 820 itself 900.

In another embodiment, a similar marketing campaign may be implemented independently, by a party or parties and for interests unrelated to either those of one or more User Account 100 holders or Manager Account 200 holders. In this case, said parties may act entirely independently or together with one or more existing account holders.

The scheduling of an event or even a more complex work calendar/schedule requires the harmonization and careful balancing of potential availabilities offered by potential attendees or alternatively and shared by multiple individuals (FIG. 6). To this end, a given organization's Manager Account 200 holder(s) must be able to consult and visualize the availability information of all User Accounts 100 affiliated with said organization over a specified time period 135, 235. The display of this data is made possible by the Availability Viewer module 450. This module communicates with the User Data module 830, from which it requests and, consistent with data encapsulation principles, is provided from the User Data module 830 all Available Time 140 and Booked Time 130 information that all affiliated User Accounts 100 have shared with said organization. Once a User Account 100 holder willingly disaffiliates from an organization or is disaffiliated from said organization by a Manager Account 200 holder, said User Account 100 holder's calendaring information, consistent with data encapsulation principles, is no longer made available to the Manager Account 200 of that organization via the Availability Viewer 450.

Certain event coordination scenarios, such as those involving the creation of a weekly work schedule for multiple employees by an organization administrator, require adherence to existing organizational policies, labor agreements, and/or applicable legislation. When necessary, some embodiments of the present invention may accordingly solicit the Labor Rules module 375 for guidance to aid a Manager Account 200 holder undertaking a schedule creation exercise. This module contains information in one or several data formats intelligible to an embodiment of the present invention, encoded by said organization or a third party, and central to the creation of schedules that must submit to a particular regulatory framework.

A further consideration pertaining to formatting relates to the data format by which a User Account 100 holder or a Manager Account 200 holder can add a specific event within his own calendar, or send event requests, tasks, and notifications to one or more other User Account 100 holders or a Manager Account 200 holders to be added to their respective calendars.

In a further deployment, it is contemplated that the ability to transmit such event information and details can be implemented using any suitable mechanism known in the art. Event information in such a context should be appreciated broadly, encompassing data contained in meeting requests, tasks, or any other notification to be transmitted between account types, or merely for one's own. Accordingly, means by which such accessing, managing, and sharing calendaring and scheduling information can be implemented non-limitingly include protocols such as those contemplated for or compatible with iCalendar format for advantageous integration with clients such as Outlook, GCal, or others. The foregoing iCalendar computer file format, for example, enables the issuing of meeting requests and tasks to other internet users. Such requests and tasks can for example be shared via email, or through some other file, URL, or information sending or retrieval module or system.

Relatedly, standards such as those discussed with, pertaining to, preceding or succeeding IETF RFC 5545 and RFC 4791 can prove particularly beneficial in representing and exchanging electronic calendaring and scheduling information. Also, technologies such as CaIDAV (and/or WebDAV) are contemplated for storing, keeping, and synchronizing various calendars across multiple servers.

Likewise, support for file extensions including but not limited to .ics (iCalendar files) and .vcs (Microsoft Outlook calendar files) can be provided in implementations. It can likewise be possible to share multiple calendars in such formats at a time, including with regular or periodic updates, with further implementations affording various encapsulation possibilities, including those described herein.

The information present in the Labor Rules module 375 is shared with the Scheduler module 500 in a manner consistent with organization and account data encapsulation principles. The Scheduler module 500 validates whether a draft schedule conforms to regulations as laid out in the Labor rules 375, and which may govern a given situation. In some embodiments of the invention, the Scheduler module 500 parses the User Data module 830 for membership information available from the Personal parameters 110 sections of each User Account 100 enumerated in the draft schedule to be validated. Next, the Scheduler module 500 matches any such membership information with any relevant and available data contained in the Labor Rules module 375.

The Scheduler module 500 may also utilize available information previously added to and contained within the Organization Data store 850 regarding inter-employee compatibility to arrive at one or several possible scheduling scenarios that not only comply with any and all required regulatory frameworks, but which are also optimized for professional and/or interpersonal compatibility

The result of this validation is output to the Availability Viewer 450, which displays the result to the Manager Account 200 holder creating the draft schedule and, where applicable, indicates the noncompliant or potentially noncompliant aspects of the current draft schedule following any incremental changes made by a Manager Account 200 holder. The Manager Account 200 holder may take the required corrective action as a result of this information.

An additional aspect of the validation described above concerns the visual presentation of various aspects of a draft or tentative schedule's appropriateness using a color code or other symbology within a schedule creation view 840 to rapidly assess said draft's absolute or relative appropriateness, in addition to whether a particular event has been variously published 844, not (yet) published 843, or published and viewed 845 by one or more attendees 100, 210, 210′.

Appropriateness may be appreciated as being a broad quality encompassing all manner of suitability or unsuitability, both objective and subjective, of a tentative schedule with respect to the persons and situations to which it is expected to apply. Said suitability and unsuitability constitute a set of both logistical and circumstantial considerations that an organization's schedule coordinator 200, 201 must or ought to take into account during the elaboration phase of one or more schedules whose subsequent publication and application using an embodiment of the present invention is sought. To this end, individual aspects, expressed or otherwise logically converted into specified rules on suitability, may be gleaned from various sources available to embodiments of the present invention. These rules are both accessible to and processed by the Scheduler 500 on an employee-by-employee 210, 210′ basis for all draft schedules elaborated, with the corresponding appropriateness information centralized and color-coded (FIG. 6, FIG. 7b) within a view of the schedule accessible within the Manager Account's 200 Manager Interface 840.

Such suitability information may, in a non-limited manner, include not only the basic Booked time 130 and Available time 140 data that a User Account 100 holder has specifically shared with an organization (and which is necessary to ascertain basic availability), but also the potentially broader and equally informative set of preferences and condition values 145, 145′ specifically expressed by the employee to said organization, including information featured within the Organization Data store 850, in addition to legislation or trade union rules governing employment aspects such as overtime, task structure, and other labor requirements as mandated by existing agreements and specified in the Labor Rules 375. For the purpose of visually presenting appropriateness, a color code legend may be devised and applied 841 to said centralized view within the Manager Interface 840, with each aspect—whether it indicates a (positive) suitability or (negative) unsuitability—assigned or assignable with a distinct color or sub-group of colors within said color code.

In deployment scenarios, additional intelligence resulting from Labor Rules 375 or other intelligence as can be found within the Organization Data 850 can be advantageously used in making staffing decisions. For example, adequate levels of staffing can be anticipated and planned in cases where details about the specific scenarios are known and supplied. For example, an organization such as a restaurant can anticipate a specific number of dinner reservations for a given evening. Automatic integration of an implementation with the restaurant's reservation system, while potentially desirable, is not envisioned as an absolute necessity. It will be appreciated that this is the case provided that pertinent information is made available to embodiments through alternate means, including manual ones involving human entry of reservation data from the reservation system. In the current example, the pertinent information corresponds to the number of reservations on a given evening. In accordance with information received by an embodiment on the number of reservations confirmed, specific triggers based on labor- or organization-related requirements can be made to activate when a given threshold of anticipated patrons is reached. A fundamental trigger can thus concern a staffing minimum to fulfill for such a given evening. Thus, shift notifications or invitations can be issued to employees by the restaurant's Manager Account 200 holder in accordance with a pre-specified number of operational roles to staff for a given reservation or event.

A variation of the above scenario can likewise be envisioned. In it, a manager overseeing a plurality of adjacent banquet halls can indicate that a banquet for 200 guests has been planned in a first hall, while a second concurrent banquet involving 40 other guests has been reserved in a second hall. On the basis of Labor Rules 375 and/or Organization Data 850, the number of specific roles (and accordingly, shifts) to fill for both events can be determined. Accordingly, the number of waiters, cooks, kitchen and maintenance staff to allocate to ensure that best practices, quality of service, and employment law are respected can be determined and the correct number of shift invitations for each type of worker can be issued.

It will be appreciated that the objective of color-coding aspects of a tentative or draft schedule's suitability is twofold. Broadly, the mere existence of a color code 841 provides a manager 200 with a visual means by which to rapidly assess whether any intrinsic or extrinsic issue exists with any scheduled employee 100 appearing within any one or more draft schedules. Further, the color-coded nature of the functionality presently discussed provides a rapid means by which to visually describe the specific nature of any known unsuitability, and in some embodiments of the invention, potentially convey hints on possible rectification measures that the Manager Account 200 holder might consider. Thus, a foolproof, adaptable, and easily operable color code symbology conveniently superimposed atop or otherwise integrated within a draft calendar view (FIG. 6, FIG. 7b) is particularly valuable as it communicates a large bandwidth of information to a human manager 200 viewer within a fairly compact layout. This in turn frequently results in a time and effort savings as it obviates the need for said manager 200 to validate whether (or, alternatively, the extent to which) a given schedule satisfies the broad set of conditional values required to satisfy each employee appearing within a tentative schedule, and where necessary, take corrective action. In addition to the inherent user-friendliness advantage procured, the functionality presently discussed is desirable in embodiments of the present invention more broadly because it precludes the inadvertent or unexpected publication of one or more schedules containing one or possibly more suitability or unsuitability aspects of which a Manager Account 200 holder would otherwise be scarcely aware.

The Availability Selector 600 and Event Booker 700 area pair of operationally independent yet functionally conjugate modules that allow an account to specify time windows, respectively, for the Available Time 140 and Booked Time 130 categories described earlier. Time windows specified as forming a User Account 100 holder's Available Time 140 are typically selected by said holder via the Availability Selector module's 600 graphical interface (FIG. 5a, FIG. 5b), present in many embodiments of the present invention.

The Scheduler module 500 inputs data from the Availability Viewer 450 to allow Manager Account 200 holders to ascertain which User Account 100 holders affiliated with the organization are available for a particular event. This information is presented via a graphical interface 840 to a Manager Account 200 holder for said organization, allowing him to select the User Account(s) 100 from which to book available time. Multiple Available Time 140 sets 146, 147 may be selected by a User Account 100 holder 101 for a given time period 141 and shared by him according to a data visibility policy that may be set and vary with his choosing. In this way, visibility of a User Account 100 holder's availabilities 146, 147 may be open to all or limited to only certain affiliated accounts 120, 143, 144. A possible exception to this policy, as discussed herein, can involve cases where a specific Manager Account 200 holder can input a state of availability for a specific User Account 100 holder for a specific organization to which the User Account 100 holder is affiliated.

Conversely, time windows corresponding to Booked Time 130 may be specified via the Event Booker module's 700 graphical interface (FIG. 4), present in various embodiments of the present invention. The Event Booker interface, in addition to the module's underlying functionality, is available to a User Account 100 as one element within the latter's User Interface 820, and thus allows a User Account 100 holder to book any time window he chooses for whatever purpose he deems necessary 130, 130′.

Contrary to the Availability Selector module 600, however, a User Account 100 holder may additionally grant Event Booker 700 functionality to and similarly revoke it from any affiliated account 120. When Event Booker module 700 functionality is granted by a User Account 100 holder to an affiliated account 120 belonging to an organization, a Manager Account 200 holder from said organization may book time windows within a User Account 100 holder's calendar.

Settings and permissions related to time booking policy (or more broadly the acceptance of an event invitation or solicitation) may be specified by the User Account 100 holder within the Personal parameters 110 section of his own account, and in some embodiments of the invention may be further subject to the more granular booking policy continuum described earlier. Consistent with his booking policy, once a User Account 100 holder has accepted an event solicitation, the time window associated with said solicitation disappears from the Available Time 140 window presented to one or more affiliated accounts (FIG. 6), consistent with the sharing policies specified by said User Account 100 holder.

In some embodiments of the invention, the Event Booker module 700 may provide a User Account 100 holder with the ability to set alternative status or courtesy messages 900 indicating how a particular time window is being used. For example, a User Account 100 holder affiliated with an amateur student sports league which typically books the same time window each week might use this courtesy message functionality to indicate that he is on vacation 131 or alternatively in an exam period during one or more occurrences of said time window. Furthermore, different courtesy messages may be specified and tailored for any or all affiliated accounts, enforcing information encapsulation principles arising from the need to address privacy considerations central to a User Account 100 holder's needs.

In keeping with the data encapsulation principles developed and discussed herein, it will be appreciated that implementations typically or primarily present to account holders, whether User Account 100 or Manager Account 200 holders, the time slots or time frames specifically relevant to each user (and user type's) immediate purposes. Thus, a User Account 100 holder will typically be presented with a user calendar upon which data relevant to that User Account 100 holder's specific management of time slots or time windows is displayed. Likewise, a Manager Account 200 scheduler view will accordingly show the various shift slots in accordance to their fulfillment by one or more User Account 100 holders.

Thus, employers can typically view information pertaining only to those timeframes for which employees have chosen to share with an organization. And for their part, employees can typically view time-related information pertaining to their own interactions with regard to accounts to which they are affiliated. In light of the abundance and complexity of timeslot-specific data that would otherwise be inherent to clusters of User Account 100 and Manager Account 200, such account-specific encapsulation and attendant limitation of information displayed is advantageous from both an interface and a usability standpoint. In particular, access and display of calendar information necessary for the purposes of each individual account's holder minimizes the negative consequences of information overload. Thus, embodiments implementing individualistic and account holder-centric display policies deliver robustness in the form of superior decision-making capabilities by all account holder types.

In another embodiment, an organization's Manager Account 200 may further possess the ability to add, within its list of member users 210, an individual placeholder for one or more User Accounts 100 who are anticipated to affiliate (but who are not currently affiliated) with the organization. The placeholder underlying a prototypical affiliation is intended to provide an expedient visual aid to an organization's Manager Account 200 holder by establishing a nominal presence for said user, within an embodiment of the present invention, which an administrator may visualize via the latter's Manager Interface 840. Such visualization facilitates the consideration of said user within said organization's logistical and scheduling-related needs by integrating a partially materialized abstraction of that user within an administrator's view 400.

Whereas the typical affiliation process between accounts occurs following an acceptance action by the party receiving the affiliation request, this is not necessarily the case with a placeholder. In various embodiments of the present invention, a placeholder is typically created by a Manager Account 200 holder of an organization on behalf of a prospective but hitherto unaffiliated member of said organization. A placeholder is thus typically instantiated to establish a prototypical, incomplete, and temporarily unfulfilled affiliation in anticipation of an eventual fulfillment, which may nonetheless be useful for any number of reasons.

By way of non-limiting examples, such prototypical affiliation may be set up (a) in advance of a member knowingly or otherwise being a bona fide part of said organization, (b) prior to the creation of a User Account 100 by said member, or (c) simply before an existing User Account 100 holder has affiliated 120 his account to the organization. A tentative prototypical affiliation exists in embodiments of the present invention as of when a placeholder is established by an organization's Manager Account 200 holder.

Prototypical affiliation may end once said placeholder (and related prototypical affiliation) is replaced with the intended User Account 100 ultimately appearing among the list of member users 210. Alternatively, prototypical affiliation may be terminated once circumstances indicate that no such replacement will occur, as for example when a courted employee, upon further reflection, notifies a potential employer he does not wish to commit to an affiliation. Data contained in such a placeholder remains accessible to said Manager Account 200 holder(s) and is exceptionally stored in one or more User Data stores 830. On the other hand, the migration of a placeholder to its intended User Account 100 counterpart proceeds by way of a duly completed traditional affiliation operation, which involves the intended target User Account 100, Manager Account 200, in addition to a validation and matching operation of the placeholder's identification parameters, further described herein. Immediately following a successful affiliation operation, calendar data previously held within the placeholder is migrated to the User Account 100's Booked Time 130 data structure.

Any conflicts resulting from this migration are detected by the Event Booker and immediately presented to said User Account 100 holder's User Interface 820 for resolution. In another embodiment, additional data assets created with and belonging to the placeholder may be transferred to the intended User Account holder 100 or permanently migrated to the Organization Data store 850. This transfer functionality may be accessible to a Manager Account holder 200 through the Manager Interface 840, and allow the former to select which data assets to permanently transfer to the intended User Account 100 holder, thereby ceding all Manager Account holders' 200 access to it.

In an embodiment of the present invention, a placeholder may be matched or otherwise reconciled with its intended User Account 100 holder through a resolution operation carried out within the Connection manager 325. Such reconciliation may be periodically and autonomously attempted by the Connection manager 325 module on the basis of any available and automatically resolvable personal identifiers within the placeholder's personal parameters 110 module. These identifiers are matched with any account, whether existing or subsequently created using an embodiment of the present invention. Reconciliation between a placeholder and an account's personal parameters 110 module includes, without limitation, an attempted match between one more of an individual's full name, email address, telephone number, or geographical coordinates present in the personal parameters 110 module.

A placeholder may consist of a limited subset of components and functionalities which typically characterize a User Account 100, which may be stored in one or more User Data stores 830, and which are further described herein. The extent to which a placeholder may contain most or even all of the components typical or integral to a User Account 100 may vary among embodiments of the present invention. It will be appreciated that a placeholder should contain a personal parameters 110 section containing, at the very least, generic identification parameters provided by an embodiment of the invention, or alternatively possess temporary identification parameters specified by a Manager Account 200 holder himself. In addition, a placeholder should minimally consist of a Booked Time 130-like data structure whose contents consist of the set of all time windows heretofore solicited by one or more Manager Account 200 holders of said organization and passively accepted by the placeholder, consistent with the visualization facility intended by a prototypical affiliation. Time windows appearing in said Booked Time 130 data structure are by default visible only to said organization's Manager Account 200 holder(s); in embodiments of the present invention, these may additionally be shared only with accounts specified by the latter.

Owing to the social nature of the interactions that principally characterize the use of embodiments of the present invention, the latter may be implemented on one or several servers distributed over a network whose breadth and accessibility may be variously wide or narrow. Accordingly, deployments may be limited to a private home or small office network, or alternatively be accessible to virtually any user connected to the internet. In such deployments, possible implementations can take the form of one or more SaaS applications, or individualized modules. As will be appreciated from the various examples discussed herein, such SaaS-based deployments can be standalone or variously interrelated.

One preferred method to access embodiments of the present invention is via a web client. Such a web client may operate on any of several commercially available web browsers, whether adapted to run on desktop or mobile platforms, with an embodiment of the present invention being hosted on one or more servers accessible via one or more URLs for the purposes of implementing and delivering the functionalities described herein. This web client is depicted as the Client/User Interface module 800, and in an embodiment of the invention, is accessed by an account holder via any of several account identification and validation mechanisms known in the art, including, without limitation, a login procedure consisting of an account identifier, email address, or other known identifier and password. A selection of personal identifier and/or password recovery mechanisms, including without limitation a function to send an existing password, or in some embodiments a temporary new one, to a known email address, may also be present.

In another embodiment, a “sign-up” functionality to create a new account having either User Account 100 or Manager Account 200 functionality may also appear at one or more URLs from which an embodiment of the present invention may be accessed. The Client/User Interface 800 also provides the channel through which are displayed the various views dynamically configured, presented, and output by the User Interface 820 and Manager Interface 840 modules, and through which the User Account 100 and Manager Account 200 holders respectively interact with the other modules of the present invention.

It is worth noting that despite the special case describing the transient aspect of the placeholder provided herein and accounts involving inanimate resources, accounts representing humans as a rule are not intended to be created by one party on behalf of another. Thus, it will be appreciated that situations in which an account is created by one individual (whether an organization member or administrator) who subsequently assigns or transfers access said account to another individual are to be avoided; embodiments of the present invention contain sufficient flexibility to obviate such a practice. As a general rule, an individual will create his own account, and affiliate with other User Accounts 100 and Manager Accounts 200, in addition to benefiting from dual account functionality if ever his involvement within one or more organizations calls for it, as described herein. Disaffiliation from individuals or organizations and subsequent affiliations with new ones mirror and parallel a lifelong process whereby relationships are variously forged, accumulated, and occasionally terminated. Likewise, ownership and control of calendar data and indeed all data assets (including their accessibility by others, wherever granted), remains with those account holders by whom such assets were created and is subject to retention only to said account holders, particularly following any disaffiliation. For example, an employer should not create, transfer, or assign accounts to new employees, nor may he automatically retain access to his former employee's calendar data, nor may said employer require that an employee surrender his account upon departure from the organization. Such a policy is particularly crucial; violating it would severely compromise both the virtual parallel to existing real life relationships as well as the potentially viral expansion model by which the present invention may grow.

While a significant portion of the discussion herein has involved scheduling of humans by other humans for specific events, it will be appreciated that corresponding management of inanimate resources are similarly contemplated. An extension of the foregoing includes combining scheduling, by implementations discussed herein, of both individuals and inanimate resources. Both resource types, namely human and inanimate, can be advantageously specified, managed, and tracked for purposes of carrying out specific logistical operations. Various levels of sophistication relating to job control can be achieved as a result of such combination. It will be appreciated that a job in such contexts can be understood to mean a representation or the delineation of a process or a sequence of operations or actions to perform. The latter operations or actions can for example form part or all of the work to be done or otherwise executed in a specific situation.

Thus, sophisticated logistical scenarios specifying, for example, what tasks are to be done, using what equipment, deployed where, by whom, and for the benefit of whom, can be specified for a given event. Accordingly, the assignment of site space, equipment, and beneficiaries (e.g. clients or patients), can be specified and coordinated with comparatively fine granularity. For example, an attendant can be assigned to ready a conference hall for an event involving 60 attendees to be held on a specified day between 7:00 and 8:00 am. A projector can be subsequently assigned for the same hall between 8:00 am and noon. Coordination of catering and wait staff to deploy refreshments at a 10:15 am coffee break lasting no longer than 20 minutes can likewise be made, as can the appropriation of adequate personnel from 2:00 pm to 3:30 pm to proceed to take down the conference hall setup and proceed with specific wrap-up or cleanup related activities.

In a further scenario, an employer can specify a combination of resource requirements, blending human and inanimate resources in addition to specifying a location where such resources should be simultaneously combined. Thus, three in-home nursing staff employed by a caregiving service provider can be assigned to a specific patient residing at a specific location for a determined amount of time, or at intervals. The location of the patient's home can in such a scenario be one parameter, in addition to the specific nursing staffing resources as well as the required servicing time windows to meet the needs and requirements for a specific service contract or transaction.

In yet a further scenario, a window cleaning service provider can specify the location (e.g. address) of a customer or job site, in addition to the requirement whereby the availability of two human staff members required to carry out the specific cleaning operations must be procured. A portion of the operation of an embodiment can in such cases consist of bringing together both human staff and inanimate resources to a specific or particular location. The building or job site, specified as one of various important parameters relating to a specific job number or contract, might in this scenario comprise an unusually large number of floors, for which an exceptionally tall ladder might be further specified (as a necessary inanimate/equipment resource) and tied to the job. Furthermore, the two human staff members can be notified of the location of the job site as one of various elements relating to a specific event, with said staff members' transportation to the job site occurring via other means, such as public transit. Other inanimate resources, such as a cleaning truck, can likewise be specified for the same job and accordingly for said job's location site. The cleaning truck and ladder can for example be managed as entirely separate resources from the individual human personnel intended to carry out the maintenance actions. They can accordingly be specified to be dropped off at a job site by a different crew affiliated the window cleaning service provider following completion of a nearby job, with said different crew members vacating the premises thereafter using their own personal means, such as through private vehicles (perhaps having parked within convenient walking distance) or via public transit.

The Manager Interface 840 presented by the Client/User Interface 800 allows a Manager Account 200 holder to carry out the administrative tasks described herein, whose nature includes, without limitation, the administration of his own account properties 202, including without limitation such identifiers as the name, contact information, social media handles, and list of other Manager Account 200 holders for the same organization. The Manager Interface module also allows a Manager Account 200 holder to carry out the investiture and divestiture of other organization administrators, in addition to the broader and typically more routine affiliation and disaffiliation actions established with other members, such as User Account 100 holders with a presence within an embodiment of the invention.

Although placeholders typically constitute limited proto-User Accounts 100, the Manager Interface module 840 uniquely allows the pool of Manager Account 200 holders of an organization to exclusively manage and otherwise manipulate each placeholder they have created to serve as a temporary abstraction for purposes of administrative and visual facility prior to an eventual mutation of said placeholder to a bona fide User Account 100. Furthermore, the Manager Interface module 840 configures the presentation and layout of multiple views of the Available Time 140, Booked Time 130, and cumulative time commitment calendar data shared with the organization by one or more affiliated User Account 100 holders (FIG. 6, FIG. 7b).

The calendar data that all affiliated accounts have chosen to make visible to the organization is processed by the Scheduler 500 and View Generator 400, before finally being expressed to the Manager Account 200 holder using any of various possible views presented by the Manager Interface module 840. Such views typically arrange and present data in any of several calendar-like views whose period may vary, as a non-limiting example, from an hourly, daily, weekly, monthly, or any other custom-specified period 235.

A Manager Account holder 200 may thus use an embodiment of the present invention to create 400, 500 one or more schedules 220, for any of various scheduling scenarios that flow from his organization's needs. Such needs may impose diverse criteria which, to cite several non-limiting and potentially combinable examples, may include scheduling one or a series of related or disparate events, each of which may span one or more time periods, and which may involve one or more distinct or overlapping sets of member users 100, 210. Accordingly, the complexity of scheduling criteria, requirements, and constraints are far from uniform, and will typically be unique to each organization.

A Manager Interface 840 view that clearly illustrates members' 210 availabilities during a specific time period, overlaid with any and all booked time windows 130 within said availabilities (FIG. 6), may provide a helpful visual conception of a potential or finalized schedule (FIG. 7b). Likewise, the process by which one or more schedules are created by a Manager Account holder 200 may be comparatively simple or more complex. In an embodiment of the present invention, schedule creation may, for example, be a purely unidirectional process whereby an organization's Manager Account holder 200 essentially imposes one or more schedules 220 unilaterally to his organization's User Account holders 100, who passively submit to it. In another embodiment, this process may allow for one or more acceptance mechanisms integrated within the User 820 and Manager 840 interfaces, which allow for notification, invitation, feedback, and a mutual agreement to be reached between User 100 and Manager 200 Account holders prior to a schedule coming into effect, with additional amendments, substitutions, or other modifications made to the schedule as necessary.

In a further embodiment, schedule creation may constitute a more formalized process consisting of several steps. In the first of these steps, a Manager Account holder may begin by creating one or more draft schedules 220 visible only to himself and/or to other Manager Account holders within the organization. Such draft schedules constitute a kind of staging area which may be informed by information supplied by any of the View Generator 400, Scheduler 500, Organization Data 850, and Labor Rules 375 knowledge. One or more draft or tentative schedules may be created by one or more Manager Account 200 holders within an organization. These schedules are initially be unpublished 843, modified any number of times due to any number of considerations, and later published (FIG. 7A, 7B) once finalized. A finalized schedule is thus made visible within each affiliated member user's 210 interface 820 once one or more Manager Account holders 200 deem it acceptable to do so. A finalized schedule may be published by way of a publishing functionality accessible within the Manager Interface 840.

Once a finalized schedule is published, the participation of each User Account holder 100, 210 so solicited may be anticipated automatically and assumed to be affirmative in all cases. In another embodiment, his participation may be subject to a prior, formal, and individual acquiescence to each schedule published and upon which his User Account 100 identifier 110 appears, with the acquiescence signaled by way of a mechanism to this end. This mechanism may include the use of a Boolean value, for instance, and be integrated and set by the member 100 via his User Interface 820. A corresponding array of acquiescence values is visible within the Manager Interface 840, the contents of which are fetched from each User Account so solicited (and alternatively for each schedule) may be viewed. In its most primitive form, the latter embodiment paves the way for subsequent communication to resolve potential scheduling conflicts. It will be appreciated that the Client/User interface 800, the User 820 and Manager 840 interfaces must accordingly be suited to accommodate such functionality, and that underlying data structures and message passing systems must be present and be sufficiently robust as to enable such embodiments of the present invention.

In another embodiment of the present invention, a more automated notification system may be implemented in which a tentative schedule 200 viewed within a Manager Interface 840 may include an option to query the View Generator 400 and Scheduler 500 to determine whether a known or potential scheduling conflict exists, given the current schedule's 200 parameters, and alert the Manager Account holder 200 accordingly. A related and complementary functionality may be integrated within a User Interface 820 to alert a User Account holder 100 of the occurrence (or possible occurrence) of a scheduling conflict following a query of his calendar data set(s) 130, 140. Finally, a combination of the foregoing may be applied, wherein a Manager Account 200 holder 201 may be presented with a schedule view (FIG. 7b) containing, for one or more time ranges 235, a full listing of events associated with his organization, the members solicited 210′, together with a status symbology identifying all such events as being variously unpublished 843 (i.e. not yet shared with one or more intended User Account 100 holders), published 844 (i.e. shared with one or more intended User Account 100 holders), or published and viewed 845 (i.e. shared with one or more intended User Account 100 holders and viewed by the latter).

In a further implementation, time clock functionality can be integrated to a User Account 100 holder's respective User Interface 820 to log employee arrival and/or departure times; or alternatively the time at which an employee begins or ends his shift when working for a specific organization to which he is affiliated. In a still further deployment, a single User Account 100 holder can likewise “check in” and “check out” of any one or more organizations from within the same User Account 100. Specific time data pertaining to such check-in and check-out actions can be input by a User Account 100 holder directly, by a supervising Manager Account 200 holder, or both. It will be appreciated that functionality relating to time stamping can in addition be integrated with modules whose functionality sorts, accumulates, or otherwise aggregates data, such as time worked by an employee, in accordance with any policy as might for example be laid out in organization data 850, or in labor rules 375 in force. Such integration might be useful, for example, to payroll departments, or in the fulfillment of any of various management objectives. Such objectives can accordingly include report generation on any one or more aspects of employment or calendaring data pertaining to an organization, and thus have varying degrees of breadth or specificity.

It will be appreciated that the check-in and check-out actions described herein can be made using any one or more computing platforms. Thus, check-in and check-out actions can be accepted by a User Account 100 holder or Manager Account 200 holder connecting to a user interface 820 or manager interface 840, respectively. Any authentication mechanism known in the art suited to a combination of the purposes described herein as well as the deployment scenario can be contemplated for such checking in and checking out actions. Accordingly, such actions can be carried out on any one or more appropriately suited platforms, which can non-limitingly include fixed or portable computing or processing functionalities. Thus, such actions can be contemplated as occurring, for any one or more User Account 100 holder or Manager Account 200 holder, on a desktop computer workstation, a laptop computer, a tablet, or a smartphone, for example. In another implementation, an individual (e.g. by way of a User Account 100) or an organization (e.g. by way of a Manager Account 200) can designate specific platforms through which check-in or check-out actions can validly occur.

In other implementations, secondary validation information, such as timestamped GPS coordinates can be derived from the aforementioned platforms. Such coordinates thus derived can confirm an employee's presence on the premises of a work site as declared, for example, when performing a “check-in” to or “check-out” from the organization corresponding to the aforementioned work site. Such logged geolocalization information can be advantageously integrated with other modules described herein, such as an organization's Employee record manager 851, as well as potentially with an organization's other information processing modules such as automated payroll tracking, described hereinabove. In a related variant, a user interface 820 can be configured to share geolocalization information pertaining to a corresponding User Account 100 holder in a manner that facilitates or, in a still further implementation, obviates, an automated check-in and/or check-out of a particular work site. Accordingly, it is contemplated that a secondary validation against Manager Account 200 schedule 220 data can be performed in cases where GPS coordinates or other geolocalization information is received from a User Account 100 holder placing him near or within a work site. Such a secondary validation can advantageously determine whether the foregoing User Account 100 holder can validly and automatedly be checked in or out of a workplace pertaining to an organization of which he is a member or is otherwise employed. Such secondary validation can advantageously assist in determining whether the aforementioned User Account 100 holder is indeed present within work premises for a scheduled shift, in which case an automated check-in can be performed, or alternatively conclude that he is merely visiting the premises outside scheduled working hours. In a corollary scenario, such secondary validation using schedule 220 information and geolocation data can likewise confirm whether an employee has indeed completed a scheduled shift, or has departed a work site prior to an agreed-upon booked time 130.

In a further implementation, an image component such as a video or photo depicting a User Account 100 holder can be required as one or more validation elements required for a successful check-in and/or check-out action relating to the foregoing timestamping functionality. Accordingly, specific policies can likewise be variously elaborated involving image components. For example, an image component can be required for check-in or check-out actions performed done using any platform, for check-ins or check-outs carried out only by specific members of an organization, for check-ins or check-outs carried out using personal mobile devices, or for check-ins or check-outs performed using only specific platforms (such as a public workstation designated for such purposes in a factory setting). Photographic evidence can in a deployment consist of a selfie having sufficient image clarity to identify an individual. It will be appreciated that such photographic evidence, particularly when combined with a timestamp and geolocation information, can advantageously provide additional certainty that an employee performing the check-in or check-out action indeed corresponds to the User Account 100 holder expected for such actions. The possibility of fraudulent, malicious, erroneous, or otherwise incorrect occurrences of check-in or check-out actions can thus be significantly attenuated. Combining a policy involving such an image component as part of a check-in or check-out action with the further requirement of a specific job site background or a well-known landmark, such as a staff room, an office waiting room or the front of a building, can further be stipulated as forming part of the validation policy.

1-23. (canceled)

24. A method of conducting data encapsulated scheduling comprising:
providing a plurality of user graphical user interfaces configured to receive time entry input corresponding to user availability, wherein each of the user graphical user interfaces is associated with a user account comprising user identification information;
for each user graphical user interface of at least a subset of the plurality of user graphical user interfaces:
receiving time entry input that is associated with at least one organization value;
generating availability data based on the time entry input and the at least one organization value;
providing a plurality of manager graphical interfaces, wherein each of the manager graphical interfaces is associated with an organization account comprising organization identification information;
receiving the availability data;
performing data encapsulation of the received availability data to process the availability data as a function of the organization value to verify if the organization value corresponds to organization identification information associated to one or more manager graphical user interfaces of the plurality of manager graphical user interfaces; and
for each of the one or more manager graphical user interfaces, rendering visible on the manager graphical user interface one or more available time entries based on the availability data with an organization value that is verified to be associated to the organization identification information associated to the manager graphical user interface on which is rendered visible the one or more time entries, wherein each available time entry of the one or more available time entries is associated to a user account allowing for booking availability of the user through the manager graphical user interface, and whereby each manager graphical user interface only has rendered visible time entries that are verified to correspond to the organization identification information of the organization account that is associated to the manager graphical user interface.

25. The method as defined in claim 24, further comprising:
receiving time booking input on at least one of the plurality of manager graphical user interfaces as a function of the one or more rendered visible time entries; and
generating time booking values as a function of the time booking input, wherein each of the time booking values is associated with the user account associated to the time entry value.

26. The method as defined in claim 25, further comprising notifying the user of a user account that is associated with the time entry that was booked.

27. The method as defined in claim 26, wherein the notifying comprises providing an identification of the booked time entry on the user graphical user interface that is associated with the user account associated to the time entry that was booked.

28. The method as defined in claim 26, wherein the notifying comprising transmitting a message notification to the phone with a telephone number that is stored in association with the user account associated with the time entry that was booked.

29. The method as defined in claim 25, further comprising updating the one or more available time entries associated with each of the other manager graphical user interfaces of the plurality of the manager graphical user interfaces that did not receive the time booking input, such that each of the other manager graphical user interfaces do not display booked time entries of a manager graphical user interface associated to an organization account with organization identification information that is other than the organization identification information associated with the organization account of the manager graphical user that has received the time booking input.

30. The method as defined in claim 24, further comprising receiving input on the user graphical user interface to join a user account associated with the user graphical user interface with an organization account, such that time entry data corresponding to the user graphical user interface is rendered visible on a manager graphical user interface associated with the joined organization account.

31. The method as defined in claim 24, further comprising receiving input on the user graphical interface to sever a user account associated with the user graphical user interface with an organization account, such that time entry data corresponding to the user graphical user interface is no longer rendered visible on a manager graphical user interface associated with the severed organization account.

32. A non-transitory storage medium comprising program code that, when executed by one or more processors, executes the method as defined in claim 24.

33. A method of network calendar scheduling comprising:
creating a table in a database, for a number of users, said table comprising:
a list of organizations associated with each one of said users,
user calendar events comprising scheduled times,
user availability entries comprising available times, and
associated data indicating for which ones of the organizations associated with said users the users are available for work or participation during said available times;
providing a user interface for said users to interface with said database table and for displaying a calendar view showing said calendar events, for accepting user input to define user calendar events and for accepting user input to define said user availability entries and said associated data separate from said user calendar events;
filtering data in said table to provide a list of a plurality of said users associated with said organizations whose said associated data indicates availability for said work or activity for a given time period;
providing a manager interface for organizations to generate an interactive display of a work or activity schedule for each of said organizations using said list;
collecting from said interactive display booking input for booking a selection of said users associated with said organizations who are available for said work or activity;
using said booking input to record calendar events in said table for said selection of said users; and
using input from said user interface or said manager interface to edit said list of organizations in said table, wherein removal of all organizations associated with one of said users does not close a user account of said one of said users.
